(19) United States
(12) Patent Application Publication
(10) Pub. No.: US 2025/0164271 A1
(43) Pub. Date: May 22, 2025

(54) INFORMATION PROCESSING DEVICE

(71) Applicant: TOYOTA JIDOSHA KABUSHIKI KAISHA, Toyota-shi (JP)

(72) Inventors: Yu NAGATA, Tokyo (JP); Takehira Ota, Inazawa-shi (JP); Daisuke Tanizaki, Okazaki-shi (JP)

(73) Assignee: TOYOTA JIDOSHA KABUSHIKI KAISHA, Toyota-shi (JP)

(21) Appl. No.: 18/825,330

(22) Filed: Sep. 5, 2024

(30) Foreign Application Priority Data
Nov. 20, 2023 (JP) 2023-196603

(51) Int. Cl. G01C 21/36; G06Q 50/06

(52) U.S. Cl. CPC G01C 21/3679; G06Q 50/06

(57) ABSTRACT

The information processing device specifies the type of the power source of the target vehicle. Further, the information processing device searches for one or a plurality of stations in which the provided power source is compatible with the specified type of the power source of the target vehicle. Then, the information processing device outputs station position information including the retrieved positions of the one or more stations to the user terminal.

### CROSS-REFERENCE TO RELATED APPLICATION

This application claims priority to Japanese Patent Application No. 2023-196603 filed on Nov. 20, 2023, incorporated herein by reference in its entirety.

### BACKGROUND

### 1. Technical Field

The present disclosure relates to an information processing device.

### 2. Description of Related Art

Japanese Unexamined Patent Application Publication No. 2023-020483 (JP 2023-020483 A) discloses a travel mode proposal device that proposes a travel mode to a destination of a vehicle. The travel mode proposal device disclosed in JP 2023-020483 A selects a first travel route to the destination by a predetermined algorithm independent of non-contact power supply. Assuming that the vehicle travels on a predetermined travel route, the travel mode proposal device estimates a value of a parameter related to an expected power supply amount that is expected to be supplied in a power supply section on the travel route in which non-contact power supply is performed from a ground power supply device to the vehicle. When the estimated value of the parameter under the assumption that the vehicle travels on the first travel route is a value indicating that the expected power supply amount is less than a predetermined reference power amount, the travel mode proposal device selects such a second travel route that the expected power supply amount is equal to or larger than the reference power amount. The travel mode proposal device proposes the first travel route as the travel route to the destination, and further proposes the second travel route when the second travel route is selected.

### SUMMARY

An object of the present disclosure is to propose to a user a visit to a station suitable for replenishing a power source of a vehicle.

An information processing device according to the present disclosure includes a control unit configured to execute:
identifying a type of a power source of a target vehicle;
searching for one or more stations where a provided power source matches the identified type of the power source; and
outputting station location information including locations of the one or more stations found by the searching to a user terminal.

According to the present disclosure, it is possible to propose to the user a visit to the station suitable for replenishing the power source of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic offensive view of a refill system;

FIG. 2 is a block diagram schematically illustrating an example of a functional configuration of a providing server;

FIG. 3 is a diagram illustrating an example of a table configuration of vehicle information held in a vehicle information database;

FIG. 4 is a diagram illustrating an exemplary table configuration of station information held in a station information database; and

FIG. 5 is a flowchart of processing executed by the control unit.

### DETAILED DESCRIPTION OF EMBODIMENTS

There are various power sources in vehicles. For example, if the vehicles are battery electric vehicle, the power source is electricity. The vehicle then needs to visit a station capable of charging. When the vehicles are fuel cell electric vehicle, the power source is hydrogen-fueled. The vehicle then needs to visit a station where hydrogen fuel can be replenished. Also, the power source may be fossil fuel (gasoline, gas oil, or gas). Then, the vehicle needs to visit a gas station or the like. The different power sources that can be provided by a station in this way may make it difficult to know which station should be visited. An information processing device according to the present disclosure solves such a problem.

The control unit of the information processing device according to the present disclosure specifies the type of the power source of the target vehicle. The control unit of the information processing device searches for one or a plurality of stations to which the provided power source is compatible with the specified type of the power source of the target vehicle. Then, the control unit outputs station position information including the retrieved positions of one or a plurality of stations to the user terminal.

As described above, the information processing device outputs station position information including positions of one or a plurality of stations capable of providing a power source to the target vehicle to the user terminal. As a result, the user can grasp the position of the station that can provide the power source to the target vehicle. In this way, a visit to a station suitable for replenishing the power source of the target vehicle can be suggested to the user.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

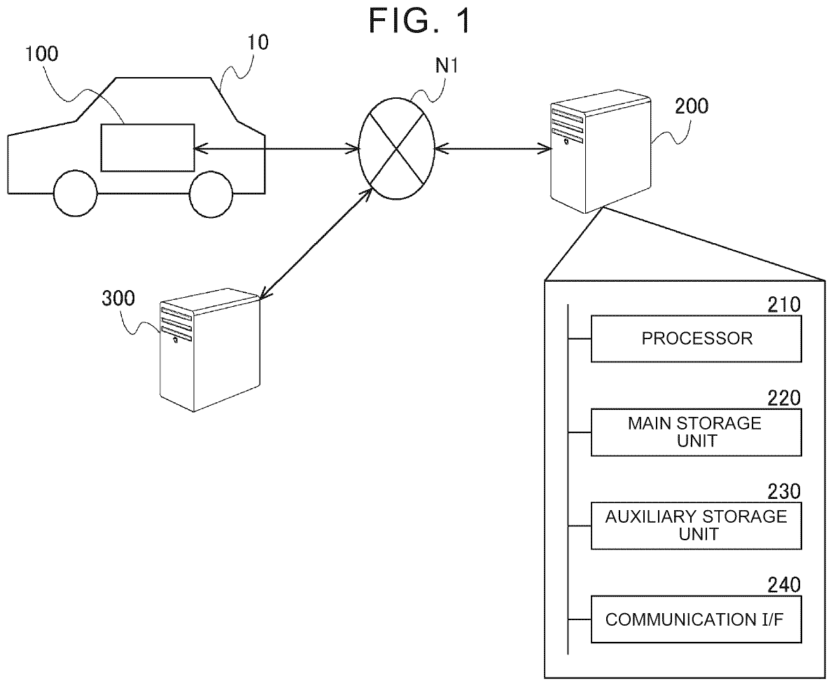

The replenishment system 1 according to the present embodiment will be described with reference to FIG. 1. FIG. 1 is a diagram illustrating a schematic offensive of a replenishment system 1. The replenishment system 1 includes a user terminal 100, a providing server 200, and a station management server 300. In the replenishment system 1, a user terminal 100, a providing server 200, and a station management server 300 are connected to each other via a network N1. The network N1 may be, for example, a worldwide public communication network such as Internet or the like, and a wide area network (WAN) or a telecommunications network such as a cellular network.

### User Terminal

The user terminal 100 is an in-vehicle terminal mounted on the vehicle 10. Here, the user terminal 100 is, for example, a car navigation system in the vehicle 10. Note that the user terminal 100 does not necessarily have to be an in-vehicle terminal of the vehicle 10. The user terminal 100 may be, for example, a computer used by a user or a personal digital assistant. Further, in the present embodiment, the vehicle 10 is a vehicle belonging to any one of battery electric vehicle and fuel cell electric vehicle types.

The user terminal 100 transmits the destination information to the providing server 200 via the network N1. The destination information is information indicating a destination of a user who boards the vehicle 10. Further, the destination information includes information indicating the current position of the vehicle 10 (the user terminal 100). In addition, the destination information includes an identifier (vehicle ID) for specifying the vehicle 10. In addition, the destination information stores information indicating the remaining amount of the power source of the vehicle 10 (the remaining amount of the battery or the remaining amount of the hydrogen fuel of the vehicle 10). The destination information is transmitted, for example, when the user of the vehicle 10 inputs the destination to the user terminal 100.

In addition, the user terminal 100 receives the route data from the providing server 200 via the network N1. The route information is information including a route from the current position of the vehicle 10 to the destination. The user terminal 100 displays (outputs) the received route information on a display. The route information displayed on the display enables the user to grasp the route information.

### Provisioning Server

The providing server 200 is a server that provides route information to the user terminal 100. The providing server 200 generates route information according to the current position and the destination of the vehicle 10 indicated by the destination information received from the user terminal 100, and transmits the route information to the user terminal 100. At this time, depending on the route of the vehicle 10, it may be necessary to supply the power source in the middle.

In this case, when the vehicle 10 is in battery electric vehicle, the power source of the vehicle 10 is electric. Then, the vehicle 10 needs to visit a station capable of charging. On the other hand, when the vehicle 10 is fuel cell electric vehicle, the power source of the vehicle 10 is hydrogen-fuel. Then, the vehicle 10 needs to visit a station where hydrogen fuel can be replenished. As described above, since the power source that can be provided differs from station to station, the user may not be able to grasp the station that is visited for replenishment of the power source of the vehicle 10.

In addition, in a station capable of providing a power source of the vehicle 10, a vehicle other than the vehicle 10 may supply a power source at the station. Thus, even a station capable of providing a power source that matches the power source of the vehicle 10 may not be able to charge or refill the vehicle 10 with hydrogen.

Therefore, the providing server 200 searches for a station (hereinafter, sometimes referred to as a “specific station”) that is a station in which the type of the power source of the vehicle 10 and the power source of the vehicle are compatible with each other and proposes a visit to the user of the vehicle 10. Then, the providing server 200 transmits route information including the scheduled traveling route via the specific station to the user terminal 100. Here, the route information includes information indicating the position of the specific station. As a result, the user of the vehicle 10 can visit the specific station while moving to the destination. Details of the specific station specifying method and the like will be described later.

The providing server 200 is configured to include a computer including a processor 210, a main storage unit 220, an auxiliary storage unit 230, and communication interfaces (communication I/F) 240. The processor 210 is, for example, a central processing unit (CPU) or a digital signal processor (DSP). The main storage unit 220 is, for example, a random access memory (RAM). The auxiliary storage unit 230 is, for example, a read only memory (ROM). The auxiliary storage unit 230 is, for example, a hard disk drive (HDD) or a disc recording medium such as a CD-ROM, a DVD disc, or a Blu-ray disc. The auxiliary storage unit 230 may be a removable medium (a portable storage medium). Examples of the removable medium include a USB memory or an SD card. The communication I/F 240 is, for example, a local area network (LAN) interface board or wireless communication circuitry for wireless communication.

In the providing server 200, an operating system (OS), various programs, various information tables, and the like are stored in the auxiliary storage unit 230. Further, in the providing server 200, the processor 210 loads the program stored in the auxiliary storage unit 230 into the main storage unit 220 and executes the program, thereby realizing various functions as described later. However, some or all of the functions of the providing server 200 may be realized by hardware circuitry such as ASIC or FPGA. Note that the providing server 200 is not necessarily realized by a single physical configuration, and may be constituted by a plurality of computers that cooperate with each other. In addition, the user terminal 100 includes a computer similarly to the providing server 200.

### Station Management Server

The station management server 300 is a server device that manages charging of a plurality of stations and replenishment of hydrogen fuel. The station management server 300 includes a computer in the same manner as the providing server 200. The station management server 300 acquires information about the usage status of each station from each station.

In addition, the station management server 300 acquires, from the vehicle, the remaining battery capacity and the battery capacity of the vehicle at the time of starting charging of the vehicle that is charging via the station. In addition, the station management server 300 acquires, from the vehicle, a remaining amount of hydrogen fuel at the start of replenishment of the vehicle that is replenishing hydrogen fuel and a capacity that can replenish the hydrogen fuel of the vehicle via the station. If there is a vehicle using the station, the station management server 300 transmits the use information to the providing server 200 in real time. Here, the usage information is information including information for specifying a vehicle (vehicle ID), information indicating a time when the vehicle starts charging or replenishing hydrogen-fuel, and information indicating a remaining amount of a power source and a capacity of a power source of the vehicle.

### Functional Configuration

Next, the functional configuration of the providing server 200 constituting the replenishment system 1 will be described with reference to FIG. 2 to FIG. 4. FIG. 2 is a block diagram schematically illustrating an example of a functional configuration of the providing server 200. The providing server 200 includes a control unit 201, a communication unit 202, a vehicle information database 203 (vehicle information DB 203), and a station information database 204 (station information DB 204).

The control unit 201 has a function of performing arithmetic processing for controlling the providing server 200 and the providing server 200. The control unit 201 can be realized by the processor 210 in the providing server 200. The communication unit 202 has a function of connecting the providing server 200 to a network N1. The communication unit 202 can be realized by a communication I/F 240 in the providing server 200.

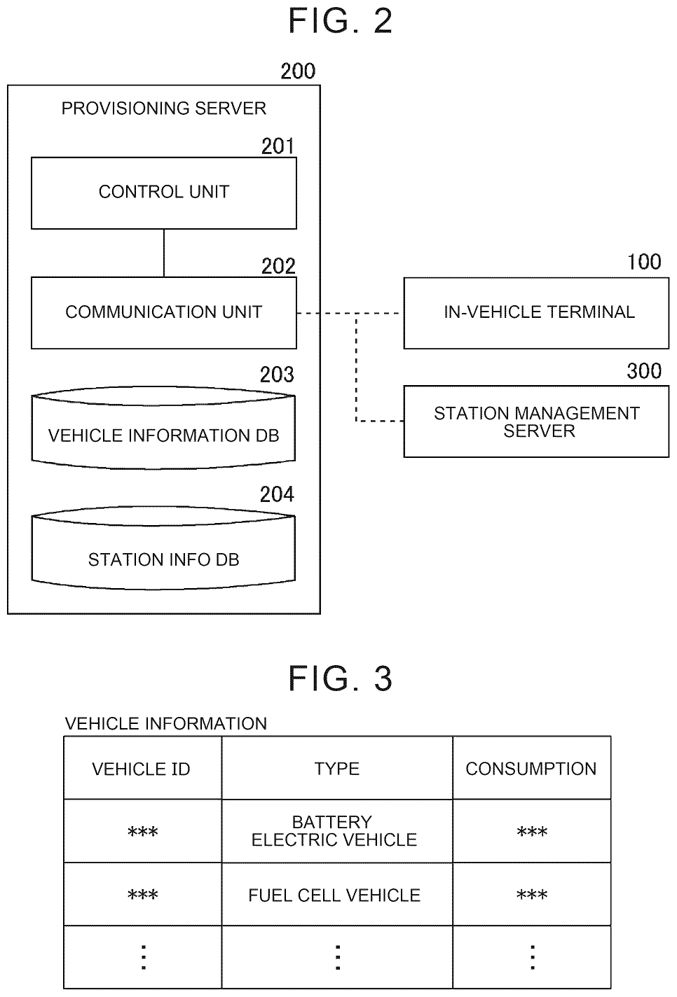

The vehicle information DB 203 has a function of storing vehicle information. The vehicle information DB 203 can be realized by the auxiliary storage unit 230 in the providing server 200. Vehicle information is information about the type of vehicle and the consumption of the power source. FIG. 3 is a diagram illustrating an exemplary table configuration of vehicle information held in the vehicle information DB 203. As shown in FIG. 3, the vehicle data includes a vehicle ID field, a type field, and a consumption field.

In the vehicle ID field, an identifier (vehicle ID) for specifying a vehicle is stored. The type field stores information indicating the type of the vehicle indicated by the vehicle ID of the corresponding vehicle ID field. In the type field, “battery electric vehicle” is stored when the type of the vehicle indicated by the vehicle ID of the corresponding vehicle ID field is battery electric vehicle. In addition, in the type field, “fuel cell electric vehicle” is stored when the type of the vehicle of the corresponding vehicle ID is fuel cell electric vehicle.

In the consumption amount field, information indicating the consumption amount of the power source of the vehicle in the corresponding vehicle ID is stored. When the vehicle of the corresponding vehicle ID is battery electric vehicle, for example, information indicating the amount of electric power consumed when the vehicle travels a unit-distance is stored in the consumption amount field. When the vehicle of the corresponding vehicle ID is fuel cell electric vehicle, for example, information indicating the amount of hydrogen-fuel consumed when the vehicle travels a unit-distance is stored in the consumed amount field. In each field in the vehicle information, information registered at the time of sale of the vehicle or the like is stored.

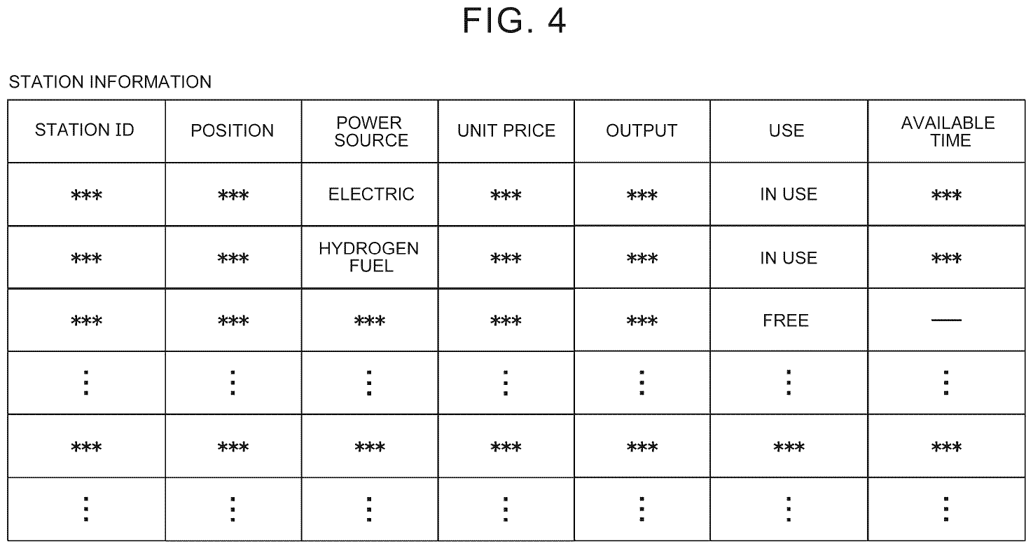

The station information DB 204 has a function of storing station information. The station information DB 204 can be realized by the auxiliary storage unit 230 in the providing server 200. The station information is information about a power source to be provided, a usage state, and the like of a plurality of stations. FIG. 4 is a diagram illustrating an exemplary table configuration of station information held in the station information DB 204.

As illustrated in FIG. 4, the station information includes a station ID field, a position field, a power source field, a unit price field, an output quantity field, a usage field, and a time-to-be-provided field. In the station ID field, an identifier (station ID) for specifying a station is stored. The position field stores information indicating the position of the station of the corresponding station ID. In the power source field, information indicating a power source that can be provided by a station of the corresponding station ID is stored. If the power source that the station can provide is electricity, then “electricity” is stored. In addition, when the power source that can be provided by the station is hydrogen fuel, “hydrogen fuel” is stored. If the station is capable of providing both electricity and hydrogen fuel, both “electricity” and “hydrogen fuel” may be input to the power source field.

A unit price field stores information indicating a unit price of a power source provided at a station of a corresponding station ID. The unit price of the power source is, for example, the price of electric power per unit electric power. The unit price of the power source is, for example, the price of hydrogen fuel per unit amount.

The output amount field stores information indicating an output amount (replenishment amount for vehicles) per unit time of the power source in the station of the corresponding station ID. When the power source that can be provided by the station of the corresponding station ID is electricity, the output amount field stores information indicating the amount of electricity output per unit time (the amount of charge per unit time). In addition, when the power source that can be provided by the station of the corresponding station ID is hydrogen fuel, the output amount field stores information indicating the output amount of hydrogen fuel per unit time (replenishment amount per unit time).

In the usage field, information indicating whether or not the station of the corresponding station ID is in use is stored. When the station of the corresponding station ID is in use, “in use” is stored. In addition, when the station of the corresponding station ID is not in use, “free” is stored.

The available time field stores the time (available time) at which charging or hydrogen fuel can be replenished at the station where “in use” is stored in the corresponding usage field. Here, the control unit 201 refers to the usage information received from the station management server 300 via the communication unit 202 and calculates the available time.

Specifically, when the power source that can be provided by the station is electricity, the control unit 201 acquires the start time of charging, the remaining battery capacity at the start of charging of the vehicle, and the battery capacity of the vehicle, which are included in the usage information of the station. Then, the control unit 201 calculates the time at which the charging ends by using the remaining battery capacity at the start of the charging of the vehicle, the battery capacity of the vehicle, and the electric output amount per unit time in the output amount field. Then, the control unit 201 stores the time at which the charging is completed as the provision possible time in the provision possible time field in the station information.

In addition, when the power source that can be provided by the station is hydrogen fuel, the control unit 201 acquires the remaining amount of hydrogen fuel at the start of replenishment of the vehicle that is replenishing hydrogen fuel and the capacity that the vehicle can replenish hydrogen fuel, which are included in the use information of the station. The control unit 201 calculates the time for completing the replenishment of the hydrogen fuel by using the remaining amount of the hydrogen fuel at the start of replenishment of the vehicle, the capacity at which the vehicle can replenish the hydrogen fuel, and the output amount of the hydrogen fuel per unit time in the output amount field.

Here, it is assumed that the power source that can be provided by the station is hydrogen fuel.

In this case, the hydrogen fuel is refilled at the station after refilling of the hydrogen fuel is completed at the station. In this way, the station can refill the vehicle with hydrogen fuel by refilling the hydrogen fuel to increase the pressure in the hydrogen fuel refill machine. Therefore, the station cannot start replenishing the hydrogen fuel immediately after the replenishment of the hydrogen fuel to the vehicle is completed.

Therefore, the control unit 201 calculates the time obtained by adding the time for refilling the hydrogen fuel in the station to the time for completing the replenishment of the hydrogen fuel in the vehicle as the provision possible time. Here, the time for refilling the hydrogen fuel is, for example, a predetermined time. Also, the time for refilling the hydrogen fuel may vary from station to station. Then, the control unit 201 stores the available time in the available time field in the station information.

In the present embodiment, the control unit 201 calculates the available time. However, the control unit 201 may acquire the available time from, for example, the station management server 300. In this case, as described above, the station management server 300 calculates the available time using the remaining amount of the power source at the start of replenishment of the power source, the capacity of the power source, and the output amount of the power source. Even in this manner, the control unit 201 can grasp the available time.

By acquiring the station information held in the station information DB 204, the control unit 201 can grasp the position of the station, the power source that the station can provide, whether the station is used, and the time at which the station can be provided.

The control unit 201 acquires destination information received from the user terminal 100. The control unit 201 acquires the current position and the destination of the vehicle 10 included in the received destination information. The control unit 201 refers to the current position and the destination of the vehicle 10, and generates a provisional route from the current position of the vehicle 10 to the destination. Here, as the provisional route, for example, a route in which the travel distance from the current position of the vehicle 10 to the destination is shortest, a route in which the travel time is shortest, or the like is generated.

The control unit 201 refers to the vehicle ID of the vehicle 10 included in the destination information and the vehicle information held in the vehicle information DB 203, and specifies the types and the consumed amounts of the vehicle 10. Here, the types of vehicle 10 are either battery electric vehicle or fuel cell electric vehicle. Thus, the control unit 201 can grasp whether the power source of the vehicle 10 is electric or hydrogen fuel.

The control unit 201 determines whether or not replenishment is necessary for the vehicle 10 to travel to the destination. Specifically, the control unit 201 calculates the travel distance on the generated provisional route. Further, the control unit 201 acquires information indicating the consumption amount of the power source of the vehicle 10 and the remaining amount of the battery or the hydrogen fuel (power source) of the vehicle 10 included in the destination information.

Then, the control unit 201 determines that the vehicle 10 needs to be replenished to travel to the destination when the remaining amount of the power source of the vehicle 10 included in the destination information is less than or equal to a predetermined value obtained by subtracting the amount of consumption expected to be consumed when the vehicle travels on the provisional route. Further, when the value obtained by subtracting the consumption amount expected to be consumed when traveling on the provisional route from the remaining battery amount or the remaining hydrogen fuel amount of the vehicle 10 included in the destination information is larger than a predetermined value, the control unit 201 determines that the vehicle 10 does not need to be replenished to travel to the destination. Here, the predetermined value is a value determined in advance as an amount of a power source capable of sufficiently traveling around the destination (capable of traveling over a predetermined distance) when the vehicle 10 arrives at the destination.

When determining that the vehicle 10 needs to be replenished to travel to the destination, the control unit 201 determines the replenishment timing of the power source of the vehicle 10. Specifically, the control unit 201 determines, as the replenishment timing, a timing at which the remaining amount of the power source of the vehicle 10 becomes equal to or less than the threshold on the provisional route. Here, the threshold value is a value determined to be suitable for replenishing the power source.

The control unit 201 refers to the station information held in the station information DB 204, and identifies a station that exists within a predetermined area from a point where the vehicle 10 is predicted to exist at the replenishment timing. The predetermined range is, for example, a range determined by a distance suitable for replenishing the power source. The predetermined range is, for example, a range in which a difference between a traveling distance or a traveling time between a case where the user does not visit the station and a case where the user visits the station is equal to or less than a threshold value.

In addition, the control unit 201 extracts, from among the stations existing within a predetermined range, a station that the power source provided to the type of the power source of the vehicle 10 matches, and identifies a station that the vehicle 10 can visit at a time when the power source can be provided as a specific station. Specifically, the control unit 201 refers to the information stored in the position field, the power source field, and the available time field in the station information, and identifies the specific station.

In addition, at this time, a plurality of stations may be present within a predetermined range, the power source provided to the type of power source of the vehicle 10 may be adapted, and the vehicle 10 may be identified as a station that can be visited at a time that can be provided. In this case, the control unit 201 refers to the unit price stored in the unit price field in the station information, and identifies the station having the lowest unit price among the plurality of identified stations as the identification station. As a result, the user of the vehicle 10 can replenish the power source at the station having the lowest unit price.

The control unit 201 corrects the provisional route and generates a scheduled traveling route. Here, the control unit 201 generates a travel scheduled route so as to visit the specific station in the middle of the provisional route. Then, the control unit 201 transmits route information including the scheduled traveling route to the user terminal 100. As a result, the user terminal 100 can visit the specific station and replenish the power source of the vehicle 10.

By referring to the position field in the station information, the control unit 201 may determine, as the specific station, the station closest to the position where the vehicle 10 is expected to exist at the replenishment timing from the plurality of stations. As a result, the user of the vehicle 10 can replenish the power source at the specific station where the movement from the provisional route is minimized. As a result, it is possible to suppress the time required for traveling to the destination and the consumption of the power source required for traveling to the destination.

### Flowchart

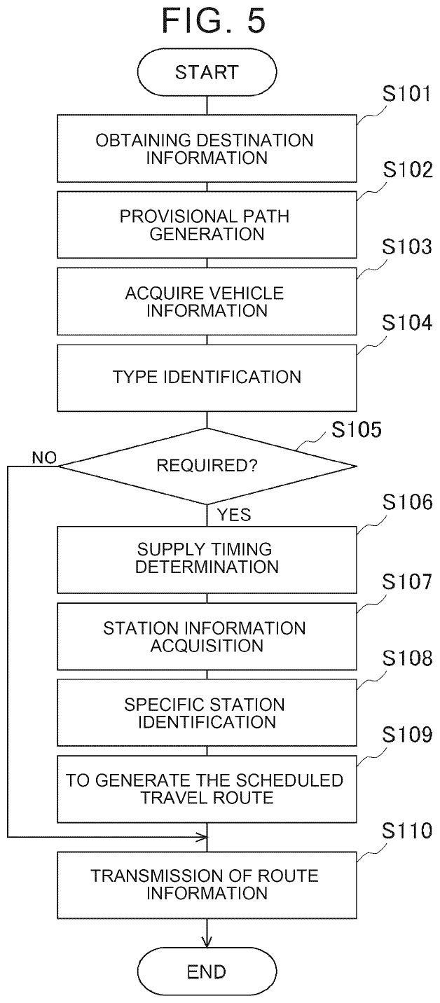

Next, a process executed by the control unit 201 of the providing server 200 in the replenishment system 1 will be described with reference to FIG. 5. FIG. 5 is a flowchart of processing executed by the control unit 201. This process is a process for transmitting route information to the user terminal 100. The processing illustrated in FIG. 5 is started when destination information is received from the user terminal 100.

In the process illustrated in FIG. 5, first, in S101, destination information received from the user terminal 100 is acquired, and the vehicle ID of the vehicle 10, the present position of the vehicle 10, and the destination are acquired. Next, in S102, a provisional route is generated according to the present position and the destination of the vehicle 10. Next, in S103, vehicle information is obtained from the vehicle information DB 203. Next, in S104, the vehicle ID of the vehicle 10 included in the destination information and the vehicle information are referred to, and the types of the vehicle 10 are identified. In other words, information indicating whether the vehicle 10 is a battery electric vehicle or a fuel cell electric vehicle is acquired, and the type of power of the vehicle 10 is identified

Next, in S105, referring to the consumed amount of the power source per unit distance of the vehicle 10 in the vehicle information, the remaining amount of the power source of the vehicle 10 included in the destination information, and the distance of the provisional route, it is determined whether or not replenishment of the power source is required for the vehicle 10 to move to the destination. When a negative determination is made in S105, it is sufficient to travel on the provisional route without replenishment of the power source, and therefore, in S109, route data on the provisional route is transmitted to the user terminal 100. Then, the process illustrated in FIG. 5 is ended.

In addition, when an affirmative determination is made in S105, it is assumed that the vehicle 10 runs on the provisional route and there is a shortage of power sources in the middle. Therefore, in S106, the replenishment timing is determined. Next, in S107, station information is obtained from the station information DB 204. Next, in S108, the station data is referenced and the particular station is identified. Specifically, among the stations that are within a predetermined range from the point where the vehicle 10 exists at the replenishment timing, a station that is suitable for providing the power source to the type of the power source of the vehicle 10 and that can be visited by the vehicle 10 at a time that can be provided is identified as a specific station. Further, when a plurality of stations can be identified as a specific station, the unit price stored in the unit price field in the station information is referred to. Among the plurality of identified stations, a station whose unit price is the smallest is identified as a specific station.

Next, in S109, the provisional route is corrected, and the scheduled traveling route is generated so as to visit the particular station in the middle of the provisional route. Then, in S110, route data about the scheduled traveling route is transmitted to the user terminal 100. Then, the process illustrated in FIG. 5 is ended.

Note that the process of S110 from S107 may be repeatedly performed at predetermined intervals until the vehicle 10 arrive at the destination. As a result, the reference of the station information, the identification of the specific station, the generation of the scheduled traveling route, and the transmission of the route information are repeatedly performed at predetermined intervals. Then, the control unit 201 can grasp, in real time, the available time that changes due to a new use by another vehicle. Therefore, when the vehicle 10 travels on the scheduled traveling route and arrives at the specific station, the control unit 201 can again specify the specific station or the like when the power source of the vehicle 10 cannot be replenished. Therefore, when another vehicle uses the specific station while the vehicle 10 is heading toward the specific station, it is possible to restrain the power source from being replenished even when the vehicle 10 arrives at the specific station.

As described above, by the replenishment system 1, when the replenishment of the power source is necessary, the scheduled traveling route via the specific station capable of providing the power source of the vehicle 10 is transmitted (output) to the user terminal 100. Accordingly, the user terminal 100 can display the scheduled traveling route including the position of the specific station to the user of the vehicle 10. As a result, the user of the vehicle 10 can grasp the position and the route of the specific station. In this way, a visit to a specific station suitable for replenishing the power source of the vehicle 10 can be suggested to the user of the vehicle 10.

### First Modification

The providing server 200 may identify a plurality of specific stations. That is, the providing server 200 may determine, as a plurality of specific stations, a plurality of stations that exist within a predetermined range from the provisional route and that can be visited by the vehicle 10 at a time when the provided power source is compatible with the type of power source of the vehicle 10.

Further, the providing server 200 may refer to the unit price stored in the unit price field in the station information, and specify, as the specifying station, a station whose unit price is equal to or less than a predetermined value among the plurality of specified stations. Then, for each specified station, route information or position information about a scheduled traveling route passing through the specified station is transmitted to the user terminal 100.

### Second Modification

In the present embodiment, the providing server 200 transmits route information including the position of the specific station and the scheduled traveling route to the user terminal 100. However, the providing server 200 may transmit the location information about the location of the specific station instead of the route information. In this case, the providing server 200 identifies, for example, a station that is within a predetermined range from the current position of the vehicle 10, and that the providing power source is compatible with the type of the power source of the vehicle 10, and that the vehicle 10 can visit from the current position at the time that the providing power source can be provided. Here, the predetermined range is, for example, a range within a predetermined distance from the current position of the vehicle 10.

Further, the providing server 200 may repeatedly perform processing of acquiring the current position of the vehicle 10, specifying the type of the vehicle 10, acquiring the available time, specifying the specific station, and transmitting the position information at predetermined intervals. As a result, it is possible to obtain the available time in real time, and it is possible to restrain the specific station from becoming unavailable even when the vehicle 10 arrives at the specific station.

### Third Modification

In the present embodiment, the types of vehicle 10 are either battery electric vehicle or fuel cell electric vehicle. That is, the power source of the vehicle 10 is either electric or hydrogen fuel. However, the types of vehicle 10 may be other than battery electric vehicle and fuel cell electric vehicle. The types of vehicle 10 may include, for example, vehicles that use fossil fuels (gasoline, diesel, and gases) in addition to battery electric vehicle, and the like. In this case, the providing server 200 identifies whether the power source of the vehicle 10 is electricity, hydrogen fuel, gasoline, light oil, or gas, searches for a station capable of providing the power source of the vehicle 10, and identifies the station as a identifying station. In this case, the providing server 200 calculates the provision possible time using the remaining amount at the start of fossil fuel supply, the tank capacity of the fossil fuel, and the output amount of the fossil fuel at the station. Even in this manner, it is possible to propose a visit to a specific station suitable for replenishing the power source of the vehicle 10 to the user of the vehicle 10.

### OTHER EMBODIMENTS

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include any type of disk such as a magnetic disk (a floppy (registered trademark) disk, an HDD, and the like) and an optical disc (such as a CD-ROM, a DVD disc, and a Blu-ray disc), a ROM, a RAM, an EPROM, an EEPROM, a magnetic card, a flash memory, an optical card, and any type of medium suitable for storing electronic instructions.

What is claimed is:

1. An information processing device comprising a control unit configured to execute:
identifying a type of a power source of a target vehicle;
searching for one or more stations where a provided power source matches the identified type of the power source; and
outputting station location information including locations of the one or more stations found by the searching to a user terminal.

2. The information processing device according to claim 1, wherein the searching for the one or more stations includes:
extracting stations where the power source is providable to the target vehicle;
acquiring providable times of the power source at the extracted stations; and
identifying the one or more stations to be visited by the target vehicle at the acquired providable times.

3. The information processing device according to claim 2, wherein the acquiring the providable times includes:
when the target vehicle is a battery electric vehicle and another vehicle is being charged at a station where electricity is providable, acquiring a time at which charging of the other vehicle is to be completed; and
when the target vehicle is a fuel cell electric vehicle and another vehicle is being replenished with hydrogen fuel at a station where the hydrogen fuel is providable, acquiring a time obtained by adding a period for refill with the hydrogen fuel at the station to a time at which replenishment of the other vehicle with the hydrogen fuel is to be completed.

4. The information processing device according to claim 1, wherein the searching for the one or more stations includes:
extracting stations where the power source is providable to the target vehicle;
acquiring unit prices of the power source to be provided at the extracted stations; and
identifying the one or more stations based on the acquired unit prices.

5. The information processing device according to claim 1, wherein:
the searching for the one or more stations includes:
extracting stations where the power source is providable to the target vehicle;
acquiring an expected timing of replenishment of the power source required when the target vehicle moves to a destination; and
identifying the one or more stations within a predetermined range from a location where the target vehicle is expected to be present at the timing; and
the station location information includes expected travel routes to the destination via the one or more stations found by the searching.
